(19) United States
(12) Patent Application Publication
(10) Pub. No.: US 2024/0183503 A1
(43) Pub. Date: Jun. 6, 2024

(54) JAR CANDLE LID

(71) Applicant: Timothy Anctil, Los Angeles, CA (US)

(72) Inventor: Timothy Anctil, Los Angeles, CA (US)

(73) Assignee: Nothing Works LLC, Los Angeles, CA (US)

(21) Appl. No.: 18/443,163

(22) Filed: Feb. 15, 2024

(51) Int. Cl. F21S 13/12

(52) U.S. Cl. CPC F21S 13/12

(57) ABSTRACT

An article of manufacture for maximizing burn time of a jar candle. The lid features a dome with a top opening and a bottom opening. In its best mode of use, the lid is positioned on top of a burning jar candle, with the bottom opening resting on the rim of the jar candle. The lid captures heat at the surface of the burning wax, assisting in a full burn of the wax to the perimeter of the jar. A plurality of rim crescents encircles the bottom opening, to seal the lid's grip on the jar and to handle the lid when the dome is hot. The rim crescents have multiple ridges with sequentially smaller diameters, for fitting candle jars of varying sizes. Venting is provided by a cylindrical chimney extending downward from the top opening, as well as a plurality of holes in the dome.

### 1. FIELD OF THE INVENTION

This invention is in the field of globes, bowls, and cover glasses, specifically lids for jar candles.

### 2. BACKGROUND OF THE INVENTION

A jar candle, a jar filled with candle wax, is a popular home décor item. High-quality jar candles can be expensive. Therefore, there is a need to maximize burn time, so as to get the best value as measured by hours per dollar. Since the flame burns at a constant rate, candle lifetime is determined by the volume of wax that is consumed versus the wax that is wasted. To be efficient, the wax must burn evenly across the diameter of the jar. A jar candle that is burned for the first time must be “set”. That is, it must burn long enough for the wax to liquify across the width of the entire vessel. Otherwise, subsequent burns melt only as far as the first burn, leading to candle “tunneling”.

### 3. DESCRIPTION OF RELATED TECHNOLOGY

A well-known remedy to help a candle set more quickly is to cover it with a “tent”, a funnel made of tin foil or aluminum foil. The foil reflects heat back to the candle, while a hole at the top allows smoke and gas to escape. Ornamental jar lids, similar to miniature lamp shades, are also well known. U.S. Pat. No. 11,378,251 (Anctil) discloses a double-cone candle shade for reducing jar candle set time. It is structured as a double conical frustum.

### 4. SUMMARY OF THE INVENTION

The present invention, the jar candle lid, is a solution for candle efficiency and functionality, maximum burn time, and increased safety. The jar candle lid is a uniquely designed dome, open on both ends. When placed atop a burning jar candle, it maximizes candle life and length of use by enclosing the candle tightly, capturing enough heat to prevent candle tunneling and ensure the full intended life of the candle. Additionally, a silicone ring at the base of the jar candle lid secures the lid to the jar and encloses the open flame from open exposure.

### 5. BRIEF DESCRIPTION OF THE DRAWINGS

FIG. 1 is an upper perspective view of the invention.

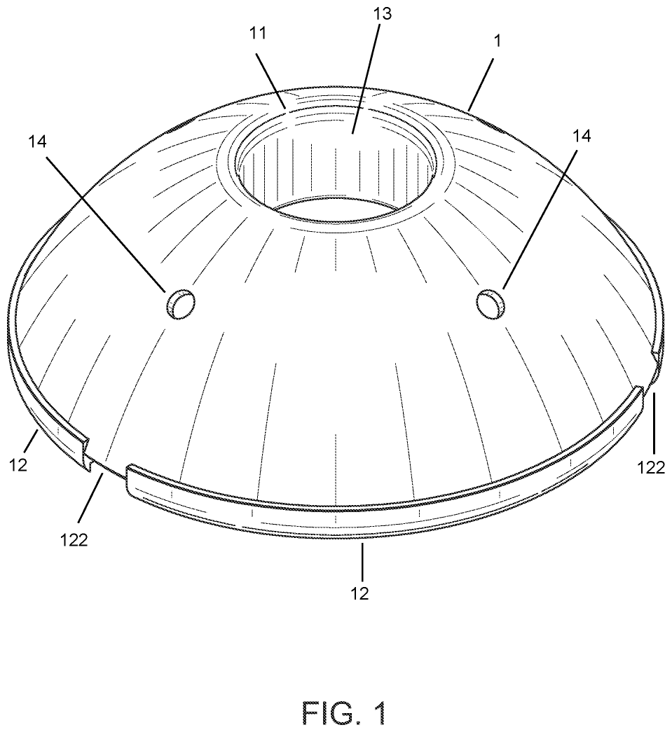

FIG. 2 is a lower perspective view of the invention.

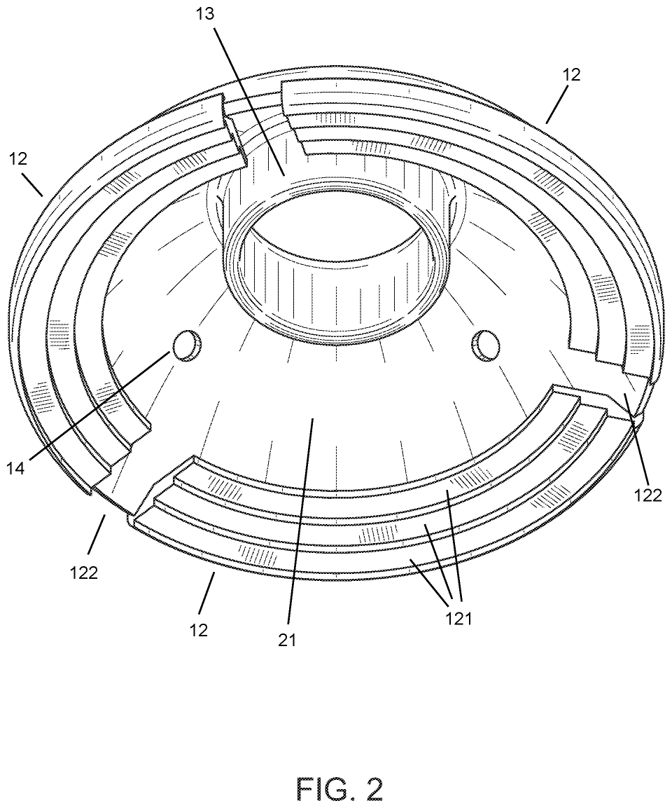

### 6. DETAILED DESCRIPTION OF THE PREFERRED EMBODIMENTS

The JAR CANDLE LID (or “lid” for short) is a decorative solution for candle efficiency and functionality, maximum burn time, and increased safety. The lid features a dome 1 with a top opening 11 and a bottom opening 21. In its best mode of use, the lid is positioned on top of a burning jar candle, with the bottom opening resting on the top of the jar candle. The lid maximizes candle life and length of use by capturing heat at the surface of the burning wax. This assists in a full burn of the wax all the way to the perimeter of the jar. The dome is ideally made of single- ply, mid-grade aluminum.

A plurality of rim crescents 12 encircles the bottom opening 21. The rim crescents secure the lid to the jar candle and enclose the flame from open exposure. The rim crescents are ideally made of silicone or a similar flexible, insulating substance. They serve as a suitable grip to touch the lid, as the aluminum dome gets too hot to handle. A plurality of spaces 122 between each adjacent pair of rim crescents 12 ensures that the candle has ample air to burn effectively.

In a preferred mode, each rim crescent 12 has multiple ridges 121. The ridges have sequentially smaller diameters. They enable the lid to fit on different sizes of candle vessels from 3″ diameter up to 4.25″ diameter.

A chimney 13 extends from the top opening 11 into the interior of the dome 1. The chimney keeps additional heat inside the lid while allowing for the venting of waste product.

The dome 1 is punctured with a plurality of holes 14, which allow light to emanate from the dome. This ensures a line of sight to the candle, so that a burning flame is not left unattended.

I claim:

1. A jar candle lid, comprising:
a dome comprising a top surface, a top opening in the top surface, a bottom opening with a rim, and an interior space between the top surface and the bottom opening;
a chimney extending from the top opening into the interior space;
a plurality of rim crescents fitted to the rim, with spaces between the rim crescents;
a plurality of holes in the top surface.

2. The jar candle lid of claim 1, in which each rim crescent comprises multiple ridges, the ridges forming concentric circles, enabling the jar candle lid to fit securely on various sizes of jar candles.
